(19) United States
(12) Patent Application Publication
(10) Pub. No.: US 2023/0041874 A1
(43) Pub. Date: Feb. 9, 2023

(54) METHOD AND APPARATUS FOR PROCESSING HUMAN BODY MODEL DATA, ELECTRONIC DEVICE AND STORAGE MEDIUM

(71) Applicant: BOE Technology Group Co., Ltd., Beijing (CN)

(72) Inventors: Jinan LI, Beijing (CN); Hua BAI, Beijing (CN); Bingdong WANG, Beijing (CN); Yangyang LIU, Beijing (CN); Guang BAI, Beijing (CN)

(21) Appl. No.: 17/790,748

(22) PCT Filed: Jun. 16, 2021
(86) PCT No.: PCT/CN2021/100335

§ 371 Date: Jul. 4, 2022

(30) Foreign Application Priority Data
Jun. 17, 2020 (CN) 202010556046.7

(51) Int. Cl. G06T 17/00; G06V 10/764; G06V 20/64; G06T 15/04; G06F 16/55

(52) U.S. Cl. CPC G06T 17/00; G06V 10/764; G06V 20/64; G06T 15/04; G06F 16/55; G06V 2201/03

(57) ABSTRACT

A method and apparatus for processing human body model data, an electronic device and a storage medium are provided. The method includes: obtaining 3D human body model data, and classifying the 3D human body model data into multiple data sets according to a predetermined classification condition, wherein the predetermined classification condition includes medical anatomy category information and art resource category information; determining, according to each of the data sets, a duplicate resource in the data set, and reorganized data sets where the duplicate resource is removed; and packing each of the duplicate resource and the reorganized data sets into a respective data package, and storing all of the data packages.

### CROSS REFERENCE TO RELATED APPLICATIONS

This application claims the priority of Chinese Patent Application No. 202010556046.7 filed in China on Jun. 17, 2020, which is incorporated herein by reference in its entirety.

### TECHNICAL FIELD

The present disclosure relates to the technical filed of Internet data processing, and in particular to a method and apparatus for processing the human body model data, electronic device and storage medium.

### BACKGROUND

With the development of computer technology, the problems that computer can deal with are more and more complex, and thus more and more data are applied and generated in the process, and the processing results obtained accordingly are more and more precise. In the process of large-scale scene processing, many types of software often need to load a large number of data files, such as basic model, material of component, high-definition map and fine special effects.

For example, in the processing of highly refined three-dimensional (3D) human body model of software application scenario, since there are many precise and exquisite characteristics of the 3D human body model, it may adversely affect the loading of these 3D human body model into the software. Since the 3D human body model has the characteristics of high precision, the 3D human body model not only owns a large data space, but also takes up a large number of data space and large mapping files.

### SUMMARY

In a first aspect, the present disclosure provides a method for processing human body model data, including:

obtaining three-dimensional (3D) human body model data, and classifying the 3D human body model data into multiple data sets according to a predetermined classification condition, wherein the predetermined classification condition includes medical anatomy category information and art resource category information;

determining, according to each of the data sets, a duplicate resource in the data set, and reorganized data sets where the duplicate resource is removed; and

packing the duplicate resource into a data package, packing each of the reorganized data sets into a respective data package, and storing all of the data packages.

In some implementations of the first aspect, the classifying the 3D human body model data into multiple data sets according to the predetermined classification condition includes:

determining a medical anatomy classification data group of the 3D human body data according to the medical anatomy category information; and

determining art resource category information corresponding to a medical anatomy system classification, and allocating art resource data that corresponds to the art resource category information and is in the 3D human body model data to the medical anatomy classification data group, to obtain the multiple data sets.

In some implementations of the first aspect, before allocating the art resource data that corresponds to the art resource category information and is in the 3D human body model data to the medical anatomy classification data group, the method further includes:

obtaining operation platform type information of the human body model data, and determining the art resource data according to the operation platform type information.

In some implementations of the first aspect, the determining, according to each of the data sets, the duplicate resource in the data set, and reorganized data sets where the duplicate resource is removed includes:

extracting, from the multiple data sets according to common information in human body medical anatomy category information, data related to the common information, and subjecting the data related to the common information to a duplicate removal process to obtain the duplicate resource; and

deleting the data related to the common information from the multiple data sets to obtain the reorganized data sets.

In some implementations of the first aspect, the art resource data includes skeletal model framework and texture for attaching onto rich skeletal model framework.

In some implementations of the first aspect, the packing the duplicate resource into the data package, packing each of the reorganized data sets into the respective data package includes:

obtaining user privilege information corresponding to the duplicate resource and each of the reorganized data sets, and adding the user privilege information to the data package.

In some implementations of the first aspect, the storing all of the data packages includes:

converting the data package into a binary data package; and

storing the binary data package.

In some implementations of the first aspect, the medical anatomy category information includes at least one of: human body shape classification information, human body organ classification information or human body system classification information;

the art resource category information includes two-dimensional (2D) resource information and 3D resource information.

In some implementations of the first aspect, the packing the duplicate resource into the data package, packing each of the reorganized data sets into the respective data package, and storing all of the data packages includes:

determining a package directory table according to the duplicate resource and each of the reorganized data sets, and the package directory table includes multiple pieces of mapping information corresponding to the data packages respectively; and storing the package directory table.

In some implementations of the first aspect, after the packing the duplicate resource into data package, packing each of the reorganized data sets into the respective data package, and storing all of the data packages, the method further includes:

in response to a data query instruction, displaying the package directory table determined according to the reorganized human body system data sets, wherein the package directory table includes multiple pieces of mapping information corresponding to the human body system data packages respectively, and the human body system data packages includes: a locomotor system data package, a nerve system data package, an endocrine system data package, a circulatory system data package, a respiratory system data package, a digestive system data package, a urinary system data package and a genital system data package; and

in response to a request for viewing a piece of mapping information in the package directory table, obtaining and displaying human body system data package corresponding to the request.

In a second aspect, the present disclosure provides a method for displaying human body model data, including:

in response to a data query instruction, obtaining a data package of a human body model corresponding to the data query instruction, wherein the data package is determined through the method provided in the first aspect of the present disclosure; and

decompressing the data package and displaying data package of the human body model.

In some implementations of the second aspect, the in response to the data query instruction, obtaining the data package of the human body model corresponding to the data query instruction includes:

in response to the data query instruction, obtaining a package directory table determined according to the reorganized human body system data set and displaying the package directory table, wherein the package directory table includes multiple pieces of mapping information corresponding to the human body system data packages respectively, and the human body system data packages include: a locomotor system data package, a nerve system data package, an endocrine system data package, a circulatory system data package, a respiratory system data package, a digestive system data package, a urinary system data package and a genital system data package; and

in response to a request for viewing a piece of mapping information in the package directory table, obtaining a human body system data package corresponding to the request.

In a third aspect, the present disclosure provides an apparatus for processing human body model data, including:

a grouping module configured for obtaining three-dimensional (3D) human body model data, and classifying the 3D human body model data into multiple data sets according to a predetermined classification condition, wherein the predetermined classification condition includes medical anatomy category information and art resource category information;

a reorganizing module for determining, according to each of the data sets, a duplicate resource in the data set, and reorganized data sets where the duplicate resource is removed; and

a packing module, configured for packing the duplicate resource into data package, packing each of the reorganized data sets into a respective data package, and storing all of the data packages.

In a fourth aspect, the present disclosure provides an electronic device, including a display, and further including:

a processor;

a memory electrically connected to the processor; and

at least one program stored in the memory and configured to be executed by the processor, wherein the at least one program is configured to implement the method provided in the first aspect of the present disclosure, or the method provided in the second aspect of the present disclosure.

In a fifth aspect, the present disclosure provides a computer readable storage medium storing therein at least one instruction, at least one program, a code set or an instruction set, wherein the at least one instruction, the at least one program, the code set or the instruction set is loaded and executed by a processor to implement the method provided in the first aspect of the present disclosure, or the method provided in the second aspect of the present disclosure.

Additional aspects and advantages of the present disclosure will be set forth in part in the description which follows, and in part will be obvious from the description, or may be learned by practice of the present disclosure.

### BRIEF DESCRIPTION OF THE DRAWINGS

The foregoing and/or additional aspects and advantages of the present disclosure will become apparent and more readily appreciated from the following description of embodiment, taken in conjunction with the accompanying drawings, wherein:

FIG. 1 is a flow diagram for a method for processing the human body model data provided by an embodiment of the present disclosure;

FIG. 2 is a flow diagram for classifying a 3D human body model into multiple data sets according to a predetermined classification condition provided by an embodiment of the present disclosure;

FIG. 3 is a flow diagram for determining a duplicate resource in the data set according to each data set, and reorganized data sets after removing the duplicate resource provided by an embodiment of the present disclosure;

FIG. 4 is a flow diagram of a method for processing the human body model data provided by an embodiment of the present disclosure;

FIG. 5 is a flow chart of an example of a human body model data query in the present disclosure;

FIG. 6 is a frame diagram of the structure of an apparatus for processing human body model data provided by an embodiment of the present disclosure; and

FIG. 7 is a frame diagram of the structure of an electronic device for processing human body model data provided by an embodiment of the present disclosure.

### DETAILED EMBODIMENT

Reference will now be made in detail to the present disclosure, embodiments of which are illustrated in the accompanying drawings, in which the same or similar reference numerals refer to the same or similar parts throughout the several views, or parts having the same or similar function. Further, if a detailed description of known technology is not necessary for illustrating the features of the present disclosure, it is omitted. The embodiments described below by referring to the drawings is exemplary only and should not be construed as limiting the present disclosure.

A person skilled in the art will understand that, unless otherwise defined, all terms (including technical and scientific terms) used herein will have the same meaning as commonly understood by a person skilled in the art to which this disclosure belongs. It will be further understood that terms, such as those defined in commonly used dictionaries, should be interpreted as having a meaning that is consistent with their meaning in the context of the related art and will not be interpreted in an idealized or overly formal sense unless expressly so defined herein.

As used herein, the singular forms “a”, “an”, “the” and “the” are intended to include the plural forms as well, unless expressly stated otherwise. As used herein, the singular forms “a”, “an”, “the” and “the” are intended to include the plural forms as well. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may also be present. Further, “connected” or “coupled” as used herein may include wirelessly connected or wirelessly coupled. As used herein, the term “and/or” includes all or any one of the units and all combinations of one or more of the associated listed items.

With the higher requirements for refining the data processing result, a large number of data files are loaded frequently, and unless there are sufficient hardware reserves, it is difficult to meet the current requirements for fast loading and running processing with respect to the large-scale data processing objects.

In addition, in the related art, displaying or editing the 3D human body model requires a large number of data files to be called or loaded, the software runs at a slow speed, and also has a high demand on computer hardware, which also tends to cause a problem of low working efficiency because the user has to wait for a long time for the software to run.

The present disclosure provides a method and an apparatus for processing the human body model data, an electronic device and a storage medium, so as to solve the above technical problem in the related art.

The technical solution of the present disclosure and how the technical solution of the present disclosure addresses the above-mentioned technical problem are described in detail below with specific reference to the embodiments.

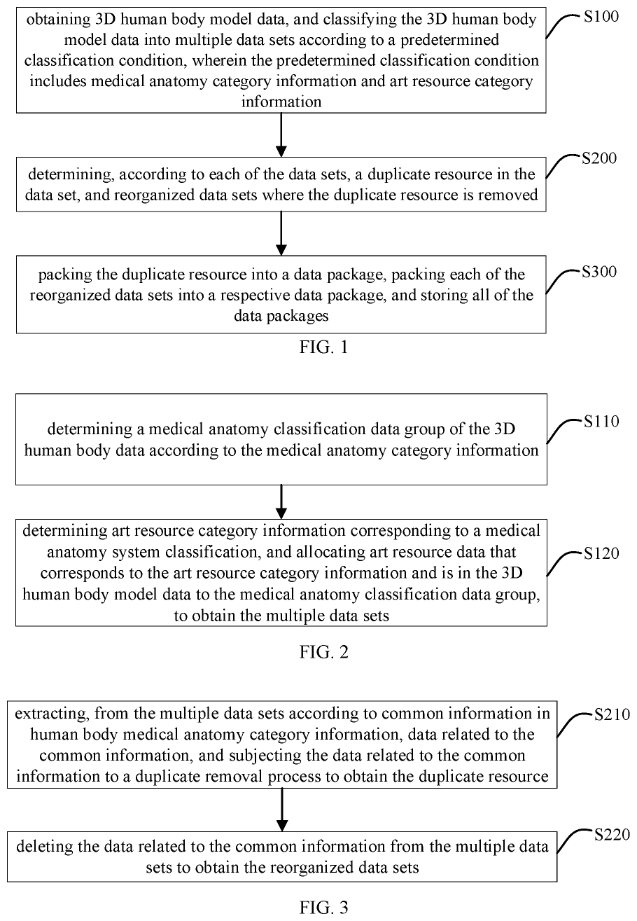

A method for processing the human body model data is provided in the embodiment of the first aspect of the present disclosure, as shown in FIG. 1, including the following steps:

step S100: obtaining 3D human body model data, and classifying the 3D human body model data into multiple data sets according to a predetermined classification condition, wherein the predetermined classification condition includes medical anatomy category information and art resource category information;

step S200: determining, according to each of the data sets, a duplicate resource in the data set, and reorganized data sets where the duplicate resource is removed;

step S300: packing the duplicate resource into a data package, packing each of the reorganized data sets into a respective data package, and storing all of the data packages.

In step S100, the apparatus obtains 3D human body model data, and in the present disclosure, the 3D human body model data is original data inputted from the outside. In addition, the apparatus herein can be either a terminal device or a server. After the preliminary classification of 3D human body model data is completed in step S100, in step S200, the classified data are subjected to a duplication removal process, and the redundant duplicate resource in the data set is reorganized to avoid the phenomenon of resource redundancy, so as to make the grouping of data clearer and facilitate data management. After obtaining clearly grouped data set in step S200, these data sets are packaged into data packages through a data packaging operation in step S300, and the complete 3D human body model data is composed of multiple data packages, and these data packages are interrelated and independent from each other, so as to allow a user to choose one or more of the data packages to load and run.

In the method for processing the human body model data provided by the present disclosure, the complete 3D human body model data is divided into multiple data sets according to the characteristics of medical anatomy category information and art resource category information, the data sets are subjected to the duplication removal process, and packed into independent data packages, such that the complete 3D human body model data is divided into multiple parts, so as to facilitate a user to load data required by the user according to needs without loading all the 3D human body data at once, thereby solving the problem of low software running speed and high requirements for equipment hardware when downloading or loading the 3D human body model; and improving the user's viewing efficiency and working efficiency.

Optionally, in an implementation of the above-mentioned embodiment, the step of classifying a 3D human body model into multiple data sets according to a predetermined classification condition in step S100, as shown in FIG. 2, specifically includes:

step S110: determining a medical anatomy classification data group of the 3D human body data according to the medical anatomy category information;

step S120: determining art resource category information corresponding to a medical anatomy system classification, and allocating art resource data that corresponds to the art resource category information and is in the 3D human body model data to the medical anatomy classification data group, to obtain the multiple data sets.

Since there are many ways to classify human body structures, in certain alternative implementations, the medical anatomy category information includes human body shape classification information, human body organ classification information, and human body system classification information. In some embodiments, the above-mentioned medical anatomy category information can also be combined; for example, after classifying the 3D human body model data according to the human body system classification information, human body system data set (such as locomotor system data set) can also be classified according to the human body organ classification information. The art resource category information is divided into 2D resource information and 3D resource information according to graphical representations.

After obtaining the medical anatomy classification data group of the 3D human body data according to the medical anatomy category information, grouping the data corresponding to the art resource category information that corresponds to the medical anatomy classification data group and is in the 3D human body data, and combining the two to obtain data set containing the medical anatomy classification data group and the corresponding art resource category information.

In other words, these data sets are divided according to the types of recorded information contents, and include at least three types: human body shape art resource data set, human body organ art resource data set and human body system art resource data set. For example, the head data may include a 3D head image having a 2D texture of elements such as relatively fine skin texture and color that are distributed on the head image according to anatomical rules, and the human body shape art resource data set may be the 2D texture.

When some users need only one of the above-mentioned three types of medical anatomy category information, e.g., the human body shape classification information, a plurality of data sets such as the head data set, the neck data set and the limb data set can be divided according to the human body shape classification information. If it needs to be classified according to the human body organ classification information, the heart data set, the eye data set, the ear data set and the liver data set, etc. In fact, each type of medical anatomy category information corresponds to a respective one type of art resource category information.

The meaning of combining the art resource category information is specifically as follows: according to the selected specific medical anatomy category information, for example, the 3D human body model data is classified into multiple human body system data sets according to the human body system classification information; then, with respect to any human body system data set (e.g., locomotor system data set), the art resource data corresponding to the locomotor system needs to be determined based on the original 3D human body model data, that is, the 3D resource and the 2D resource of the locomotor system. The 3D resource is a skeletal model framework, which is specifically provided by a modeling software, and the 2D resource is texture capable of attaching onto a rich skeletal model framework, for example, a picture capable of reflecting bone material and color. There is also a correspondence between the 3D resource and the 2D resource in art resource data, and the 3D model frame formed by the 3D resource needs to be filled by the corresponding 2D resource.

Optionally, in another implementation of the above-mentioned embodiment, in the step of classifying 3D human body model data into multiple data sets according to a predetermined classification condition in S100, determining the predetermined classification condition further includes: obtaining type information about operation platform of human body model data, and determining art resource data according to the type information.

To classify the 3D human body model data, it is also necessary to consider the operation platform which will run the 3D human body model data. Since the application scenarios of the operation platform are different and the hardware performance is different, in order to ensure the smooth running of the 3D human body model data, the type of the operation platform should also be taken as one of the predetermined classification conditions to formulate a personalized classification strategy. In some embodiments, the operation platform running 3D human body model data may be considered in determining art resource data.

Generally, the performance of a Personal Computer (PC) end is better and the ability to load data packets is stronger, so a richer 3D human body model data classification mode can be used; however, a general mobile terminal usually needs to download data packets depending on data traffic provided by a mobile operator; therefore, in order to enable a user to quickly view information on the 3D human body model, a large single data package should not be used, for example, a single data package should not exceed 20M. For example, when the type of the operation platform is a mobile terminal, a human body organ classification information can be selected as medical anatomy category information to provide a relatively large amount of data package with a small amount of data in a single data packet. Optionally, the human body shape classification information or the human body system classification information can be selected as the medical anatomy category information, but the art resource data with a smaller image definition is correspondingly selected, so as to ensure that the data quantity of each data package is within a predetermined range.

In the procedure of processing highly refined 3D human body model of the software application scenario, with the refinement of human body data collection, it is necessary to simulate human body with more refined and realistic 3D model for people to understand the condition of human body or make medical analysis, and it is also necessary to have more human body structure information files and corresponding more realistic and detailed texture files. These data files occupy a huge data space. In addition, when performing Asset Bundle (AB) package packing operation on the 3D human body model, due to the possible reuse of model textures, a great deal of texture redundancy is generated when performing the AB package packing, which further increases the size of the whole 3D human body model data and increases the burden of software downloading and loading. In addition, calling a single large AB package in the software will also adversely affect the normal use of the software.

Therefore, in still other alternative implementations of the above-mentioned embodiments of the present disclosure, as shown in FIG. 3, the step 200 of determining, according to each of the data sets, a duplicate resource in the data set, and reorganized data sets where the duplicate resource is removed specifically include:

step S210: extracting, from the multiple data sets according to common information in human body medical anatomy category information, data related to the common information, and subjecting the data related to the common information to a duplicate removal process to obtain the duplicate resource;

step S220: deleting the data related to the common information from the multiple data sets to obtain the reorganized data sets.

In some embodiments, the common information may include information about body parts such as blood vessel, skin and muscle, and in each of the medical anatomy classification data groups, such as the head data set and the trunk data set, there may be the 2D textures of blood vessel, skin and muscle, etc. The 2D texture of these body parts is duplicate resource, and the duplicate resource needs to be extracted from each data set (meanwhile, the extracted duplicate resource is to be deleted from the original grouping data set) and a duplication removal process is to be performed. It is then packed into the respective data package for common information.

The technical idea of step S200 is to first analyze the data set obtained in step S100 one by one to find out the duplicate resource existing in the data set, wherein the duplicate resource may be derived from two data sets, or may be derived from three data sets, or may be shared by all the data sets. One source of duplicate resource is the transitional human body structure or tissue on the 3D human body, and duplicate resource is different according to the specific medical anatomy category information being used. The duplicate resource is recognized and packaged separately, which can reduce the redundancy of each data set and facilitate data management.

For example, the texture and appearance of the human body skins (e.g., the skin on the face and the skin on the abdomen, etc.) are mostly the same; the 3D human body model is grouped according to the human body shape classification information to obtain head data set and trunk data set, and the grouping resource representing the skin appearance and texture is duplicate resource, which does not need to include the above-mentioned duplicated texture resources in both the head data set and the trunk data set.

After classifying 3D human body model data into multiple groups of data set according to user requirements and organizing the same, the embodiments of the present disclosure further provide an alternative implementation mode, i.e., in step S300, packaging each of the duplicate resource and the organized data sets into a respective data package and storing same, specifically including:

obtaining user privilege information corresponding to the duplicate resource and each of the reorganized data sets, and adding the user privilege information to the data package.

The user privilege information is added during the process of performing data packaging operation on the data set, so as to realize the orderly management of data package and providing a convenient way for commercial operation. Users with different user information download and load data package according to their respective authorized ranges, and use the data packages in different manners and based on respective information viewing ranges. The user privilege information includes, e.g., an update privilege, customized privilege.

Optionally, another implementation is provided in the embodiment of the present disclosure, wherein each of the duplicate resource and the reorganized data sets is packed into the respective data package and stored in step S300, including: converting each of the data packages into a respective binary data package; storing the binary data package.

Generally speaking, data will be transferred in the form of characters, which, however, is not applicable to the 3D model. Since the size of the data packet of the 3D model is generally large, and the transfer efficiency in the form of the characters is very low, the binary transmission may avoid the decoding process of characters, so that the data can be directly recognized by the processor, and thus the loading efficiency of the data package can be greatly improved. In particular, the data package of the 3D human body model is transcoded into a binary file through an editor (such as a Unity editor), so that the space occupation ratio of the data package in the server becomes small, facilitating rapid downloading at the client end. After downloading data package of the 3D human body model, the client end can also read and display the data directly and quickly, avoiding the intermediate translation.

It should be appreciated that in an alternative implementation of the present disclosure, the medical anatomy category information includes at least one of: human body shape classification information, human body organ classification information or human body system classification information; the art resource category information includes 2D resource information and 3D resource information.

In some embodiments, classifying the 3D human body model data into multiple human body shape data set according to the human body shape classification information, or classifying the 3D human body model data into multiple human body organ data set according to the human body organ classification information, or classifying the 3D human body model data into multiple human body system data set according to the human body shape classification information.

In some embodiments, in the step S300 of the packing the duplicate resource into the data package, packing each of the reorganized data sets into the respective data package, and storing all of the data packages includes:

determining a package directory table according to the duplicate resource and each of the reorganized data sets, and the package directory table includes multiple pieces of mapping information corresponding to the data packages respectively; and storing the package directory table.

To facilitate understanding of the disclosed method for processing the human body model data, a specific example is described as follows.

When the 3D human body model data is classified according to the human body shape classification information, according to step S200, it may determine the duplicate resource of the human body shape, and the reorganized human body shape data sets, i.e., the reorganized head data set, neck data set and limb data set, etc. Then, duplicate resource package of human body shape and human body shape data package are obtained in step S300, such as data package, head data package, neck data package and limb data package of shared skin, etc. The data package obtained by step S300 has a correspondence with the 3D human body model, and all the data package includes the complete data of the 3D human body model, and this correspondence provides an index table for subsequent data management and user access and use.

The data packages are derived from the data sets and correspond to the data sets respectively; each of the data sets corresponds to a respective one part of the 3D human body model; the number of the data package is the number of mapping information in the package directory table; the package directory table including these one-to-one corresponding mapping information is stored together with the data package; and the dispersed data package is re-associated as a complete whole via the package directory table. The package directory table can specifically set two index levels; the first level includes a directory corresponding to the medical anatomy category information, and the second level includes a directory corresponding to each data package in each medical anatomy category information, so as to quickly find the data package required by the user in the case of using more medical anatomy category information. It should be noted that, the package directory table may also be provided with more index levels, and the present application is not limited thereto.

Optionally, in some specific embodiments of the above-mentioned implementation methods, after the step of packing the duplicate resource into the data package, packing each of the reorganized data sets into the respective data package, and storing all of the data packages, the method further includes:

in response to a data query instruction, displaying the package directory table determined according to the reorganized human body system data sets, wherein the package directory table includes multiple pieces of mapping information corresponding to the human body system data packages respectively, and the human body system data packages include: a locomotor system data package, a nerve system data package, an endocrine system data package, a circulatory system data package, a respiratory system data package, a digestive system data package, a urinary system data package and a genital system data package; and

in response to a request for viewing a piece of mapping information in the package directory table, obtaining and displaying human body system data package corresponding to the request.

When the human body system classification information is used to classify the 3D human body model data, it may obtain the human body system grouping information includes the locomotor system data set, the nerve system data set, the endocrine system data set, the circulatory system data set, the respiratory system data set, the digestive system data set, the urinary system data set and the genital system data set, and then respectively obtain, according to the human body system grouping information and the related art resource data, the locomotor system data package, the nerve system data package, the endocrine system data package, the circulatory system data package, the respiratory system data package, the digestive system data package, the urinary system data package, the genital system data package, and the human body system duplicate resource data package.

When the apparatus receives the data query instruction, it indicates that the user has sent out the query requirement of the 3D human body model information, and finds the data package correspondingly according to the data query requirement, and it displays the data package through the relevant display device, so as to achieve the purpose of the user viewing the required human body information.

For example, the user wants to view the information related to the locomotor system on the mobile phone, the user opens the related application software on the mobile phone, and it displays the human body shape classification information, the human body organ classification information and the human body system classification information on the display interface of application software. When the human body system classification information is selected therefrom, the package directory table corresponding to the locomotor system data package, the nerve system data package, the endocrine system data package, the circulatory system data package, the respiratory system data package, the digestive system data package, the urinary system data package and the genital system data package is displayed on the display interface. Then, when the user selects the locomotor system data package, the mobile phone calls the 3D human body model data corresponding to the locomotor system data package accordingly and displays same. The viewing of data package reorganized according to other types is similar to this process and will not be described in detail.

The embodiment of the second aspect of the present disclosure provides a human body model data display method, specifically including: in response to a data query instruction, obtaining a data package of a human body model corresponding to the data query instruction, wherein the data package is determined through the method according to any one of claims 1-10; and decompressing the data package and displaying data package of the human body model.

Optionally, in a specific implementation of the method, in response to the data query instruction, obtaining the data package of the human body model corresponding to the data query instruction includes: in response to the data query instruction, obtaining a package directory table determined according to the reorganized human body system data set and displaying the package directory table, wherein the package directory table includes multiple pieces of mapping information corresponding to the human body system data packages respectively, and the human body system data packages include: a locomotor system data package, a nerve system data package, an endocrine system data package, a circulatory system data package, a respiratory system data package, a digestive system data package, a urinary system data package and a genital system data package; and in response to a request for viewing a piece of mapping information in the package directory table, obtaining a human body system data package corresponding to the request.

The above-mentioned implementation is a process executed by the apparatus according to a user's data query instruction when the data package is specifically human body system data package, and for the other type of data package, specifically for a human body shape classification information and a human body organ classification information, the process of presenting a specific medical anatomy category information according to the user's data query instruction corresponding thereto is similar, and the description thereof will not be repeated.

In addition, the above-mentioned process can be implemented at the client end or the server end, and can also be implemented in the case that the client end is combined with the server end. For example, an application for displaying the 3D human body model is deployed at the client end, the package directory table is displayed at the client end (the package directory table establishes an information link with the package directory table of the server end) according to the user's requirements. Then, according to the user's selection of data package on the package directory table, that is, the request for viewing the package directory table, it downloads the data package from the server. For example, when the user wants to view the locomotor system of the human body system, a package directory table classified by the human body system is determined in the step S300, a viewing request that the user wants to see the locomotor system is sent to the server, the server returns the stored locomotor system data package to the client end, and the required human body locomotor system model can be displayed on the client end after being downloaded by the client end.

To more conveniently understand the overall process of the present disclosure human body model data processing, one practical implementation thereof is described as follows.

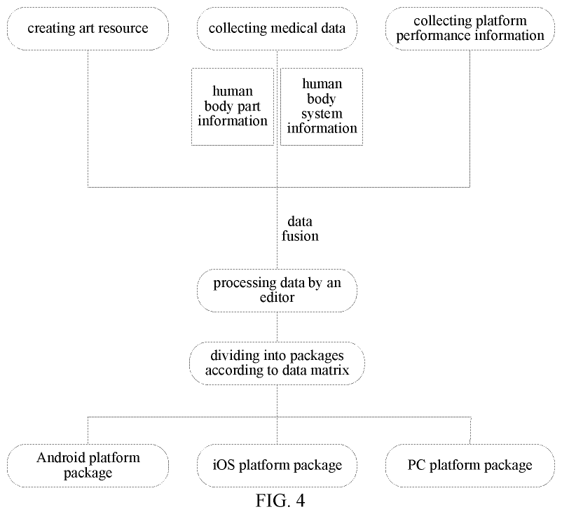

As shown in FIG. 4, the original data collection of a 3D human body model is realized firstly, which mainly includes three aspects: creating the art resource, collecting the medical data and collecting the platform performance information, wherein collecting the medical data at least includes two aspects, i.e., the human body local information and the human body system information. The art resource and the medical data correspond to each other, and at the same time, the number of collected types of the medical data is determined according to the platform performance information. After collecting the above-mentioned data, performing data fusion to obtain original data of the 3D human body model. The art resource is created by human body image data collection equipment. For example, the X-ray machine can be used to obtain the bone state of the human body, the camera can be used to obtain the bone picture after anatomy, and the image processing software can be used to render and synthesize the image. The medical data is obtained from various devices for obtaining human body biological information as well as the database, etc. In addition, the platform performance information can be directly identified by the terminal device with identification chip or server when communicating with the accessed platform. These original data can be transmitted to the terminal device or the server by communicating with the terminal device or the server.

The terminal device or the server performs data processing on the obtained original data of the 3D human body model, and specifically performs data processing through an editor in the device. The content of the data processing is to classify the 3D human body model data into multiple data sets according to the predetermined classification condition, wherein the predetermined classification condition includes the medical anatomy category information and the art resource category information; for example, it can be performed by using Unity editor in Unity 3D (a fully integrated professional game engine developed by Unity Technologies Company), and the device perform package division operation according to a data matrix to obtain the data packages; in this process, the data matrix represents the predetermined classification condition consisting of three elements of the medical anatomy category information, the art resource category information and the operation platform type information, wherein a data matrix is a data processing format of Unity 3D, information such as the medical anatomy category information and the art resource category information is specifically expressed in the form of the data matrix. After that, it may obtain the data packages running on multiple platforms, such as Android platform package, iOS platform package and PC platform package, wherein each platform package includes the data packages obtained according to one or more medical anatomy category information classifications.

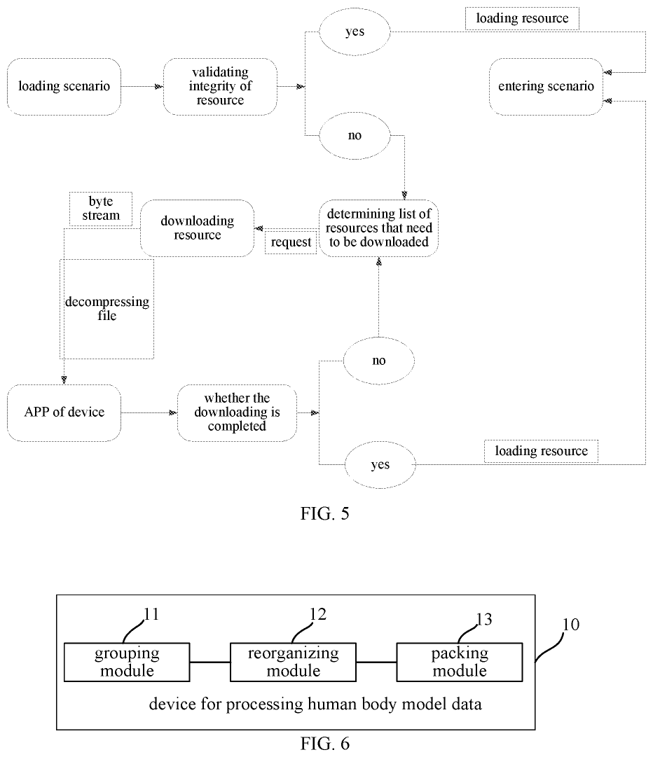

As shown in FIG. 5, when a user uses the terminal device, firstly, the user touches the relevant application software on the terminal device display screen, the application software in the terminal device is started according to the touch operation of the user, and the terminal device loads the scenario, i.e., various human-machine interaction interfaces displayed on the display screen of the terminal device, e.g., a query interface, and the 3D human body model and various parts thereof are displayed in the query interface. Then, it receives a selected operation for some parts of the displayed 3D human body model inputted by a user on the basis of a touch, a gesture or voice, confirming that a human body model information search request for these parts is received by the user; a terminal device checks the integrity of the resource, and determines the integrity of the data package corresponding to the submitted search request. If the data package is stored in the terminal device and the integrity of the resource is valid, the resource is loaded to enter the scenario, and the user views the human body model data on the display screen of the terminal device.

If the terminal device fails to validate the integrity of the resource, it determines that a resource list is to be downloaded from the server, so as to download the data package list corresponding to the viewing request of the user accordingly, wherein the list may include one data package or multiple data package. The data package is downloaded from a server in the form of a byte stream or is downloaded from a local storage of a terminal device to a cache, a decompression operation and/or a decryption operation is performed on a downloaded resource through the application of the terminal device. Then, it determines whether the downloading is completed; if the downloading is completed, i.e., “yes” in FIG. 5, a resource loading operation is performed again; and if the downloading is not completed, i.e., “no” in FIG. 5, a resource list needing to be downloaded continues to be determined. Through the above-mentioned process, the user may view the 3D human body model.

In the above-mentioned process, if the participation of the server is required, the server provides a data package list corresponding to the viewing request to be downloaded by the terminal device according to a human body model information viewing request generated by a user on the terminal device, and sends the data package list to the terminal device.

An embodiment of a third aspect of the present disclosure provides an apparatus for processing human body model data 10, as shown in FIG. 6, including a grouping module 11, a reorganizing module 12 and a packing module 13, wherein:

the grouping module 11 is configured for obtaining 3D human body model data, and classifying the 3D human body model data into multiple data sets according to a predetermined classification condition, wherein the predetermined classification condition includes medical anatomy category information and art resource category information;

the reorganizing module 12 is configured for determining a duplicate resource in the data set according to each data set, and the reorganized data sets where the duplicate resource is removed; and

the packaging module 13 configured for packing the duplicate resource into data package, packing each of the reorganized data sets into a respective data package, and storing all of the data packages.

The device for processing human body model data provided by the present disclosure divides the complete 3D human body model data into multiple groups according to the characteristics of the medical anatomy category information and the art resource category information, the data sets are subjected to the duplication removal process, and packed into independent data packages, such that the complete 3D human body model data is divided into multiple parts, so as to facilitate a user to load data required by the user according to needs without loading all the 3D human body data at once, thereby solving the problem of low software running speed and high requirements for equipment hardware when downloading or loading the 3D human body model; and improving the user's viewing efficiency and working efficiency.

Optionally, in some implementations of the embodiments described above, the grouping module 11 is further configured for:

determining a medical anatomy classification data group of the 3D human body data according to the medical anatomy category information; and

determining art resource category information corresponding to a medical anatomy system classification, and allocating art resource data that corresponds to the art resource category information and is in the 3D human body model data to the medical anatomy classification data group, to obtain the multiple data sets.

Optionally, in some implementations of the embodiments described above, the grouping module 11 is further configured for:

obtaining operation platform type information of the human body model data, and determining the art resource data according to the operation platform type information.

Optionally, in other implementations of the above embodiments, the reorganizing module 12 is further configured for:

extracting, from the multiple data sets according to common information in human body medical anatomy category information, data related to the common information, and subjecting the data related to the common information to a duplicate removal process to obtain the duplicate resource; and

deleting the data related to the common information from the multiple data sets to obtain the reorganized data sets.

Optionally, in some implementations of the embodiments described above, the packing module 13 is further configured for:

obtaining user privilege information corresponding to the duplicate resource and each of the reorganized data sets, and adding the user privilege information to the data package.

Optionally, in other implementations of the above embodiments, the packing module 13 is further configured for:

converting each of the data packages into a respective binary data package; and

storing the binary data packages.

Optionally, in other implementations of the above embodiments, the medical anatomy category information includes at least one of: human body shape classification information, human body organ classification information or human body system classification information;

the art resource category information includes two-dimensional (2D) resource information and 3D resource information.

The packaging module 13 is further configured for:

determining a package directory table according to the duplicate resource and each of the reorganized data sets, and the package directory table includes multiple pieces of mapping information corresponding to the data packages respectively; and

storing the package directory table.

In the above-mentioned implementation, the packaging module 13 is further configured for:

in response to a data query instruction, displaying the package directory table determined according to the reorganized human body system data sets, wherein the package directory table includes multiple pieces of mapping information corresponding to the human body system data packages respectively, and the human body system data packages includes: a locomotor system data package, a nerve system data package, an endocrine system data package, a circulatory system data package, a respiratory system data package, a digestive system data package, a urinary system data package and a genital system data package; and

in response to a request for viewing a piece of mapping information in the package directory table, obtaining and displaying human body system data package corresponding to the request.

Based on the same inventive concept, the embodiments of the present disclosure further provide an electronic device, the electronic device including a display and further including: memory and processor. The memory is electrically connected to the processor. At least one computer program stored in the memory, when executed by the processor, is configured for implementing various alternative embodiments of the method for processing the human body model data or the method for displaying the human body model data provided by the embodiments of the present disclosure.

It will be appreciated by the person skilled in the art that the electronic device provided by the embodiment of the present disclosure may be specially designed and manufactured for the required purposes, or may include a known equipment in a general purpose computer. The equipment has computer program stored therein, the computer program being selectively activated or reconfigured. Such a computer program may be stored in a device (e. g. computer) readable medium or in any type of medium suitable for storing an electronic instruction and respectively coupled to a bus.

Compared with the related art, by means of the electronic device provided in the present disclosure, a user does not need to load all 3D human body data at once, thereby solving the problem of low software running speed and high requirements for equipment hardware when downloading or loading the 3D human body model; and improving the user's viewing efficiency and working efficiency.

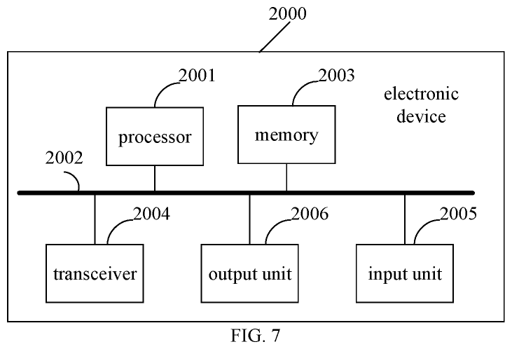

The present disclosure provides a, electronic device in an alternative embodiment, as shown in FIG. 7, the electronic device 2000 includes a processor 2001 and a memory 2003. The processor 2001 and the memory 2003 are electrically connected via e.g., a bus 2002.

The processor 2001 may be a CPU (Central Processing Unit), a general-purpose processor, a DSP (Digital Signal Processor), an ASIC (Application Specific Integrated Circuit), an FPGA (Field-Programmable Gate Array) or other programmable logic device, a transistor logic device, a hardware component, or any combination thereof. It may implement or perform the various logical blocks, modules and circuits described in connection with the present disclosure. The processor 2001 may also be a combination that implements the computing functionality, e.g., the combination including one or more micro-processor, a combination of a DSP and a micro-processor, etc.

The bus 2002 may include a pathway to transfer information between the components described above. The bus 2002 may be a PCI (Peripheral Component Interconnect) bus or an EISA (Extended Industry Standard Architecture) bus or the like. The bus 2002 may include an address bus, a data bus, a control bus, etc. For convenience, only one bold line is shown in FIG. 7 for representing the bus 2002, but does not indicate that there is only one bus or one type of bus.

The memory 2003 may be a ROM (Read-Only Memory) or other type of static storage equipment that may store static information and an instruction, a RAM (Random Access Memory) or other type of dynamic storage equipment that may store information and an instruction, it can also be EEPROM (Electrically Erasable Programmable Read Only Memory), CD-ROM (Compact Disc Read Only Memory) or other optical disc storage, optical disc storage (including compact disc, laser disc and optical disc, digital versatile disc, blue-ray disc), storage medium or other magnetic storage equipment, or any other medium that can be used to carry or store desired program code in the form of an instruction or data structure and that can be accessed by a computer, but is not limited thereto.

Optionally, the electronic device 2000 may also include a transceiver 2004. The transceiver 2004 may be configured for signal reception and transmission. The transceiver 2004 may allow the electronic device 2000 to communicate wirelessly or wired with other equipment to exchange data. It should be noted that the quantity of the transceiver 2004 is not limited to one in practice.

Optionally, the electronic device 2000 may also include an input unit 2005. The input unit 2005 may be used to receive numbers, characters, images, and/or audio information that are inputted, or to generate key signal inputs related to user settings and function controls for the electronic device 2000. The input unit 2005 may include, but is not limited to, one or more of touch screen, physical keypad, function key (such as volume control key, switch key), trackball, mouse, joystick, image capturing apparatus, microphone, etc.

Optionally, the electronic device 2000 may also include an output unit 2006. The output unit 2006 may be used to output or display information processed by the processor 2001. The output unit 2006 may include, but is not limited to, one or more of a display device, a speaker, a vibration device, etc.

While FIG. 7 illustrates an electronic device 2000 with various components, it should be understood that not all illustrated devices are required to be implemented or provided. More or fewer devices may alternatively be implemented or provided.

Optionally, the memory 2003 is used to store application program for implementing the scheme of the present disclosure, and the implementation is controlled by the processor 2001. The processor 2001 is used to execute application program stored in the memory 2003 to implement any method for processing the human body model data or any method for displaying the human body model data provided by embodiment of the present disclosure.

Based on the same inventive concept, the embodiments of the present disclosure provide a computer readable storage medium, the computer readable storage medium having a computer program stored thereon, wherein the program, when executed by a processor, implements any method for processing the human body model data or any method for displaying human body model data provided by the embodiments of the present disclosure.

The readable storage medium provided by the embodiments of the present disclosure, compared with the related art, does not need to load all 3D human body data at once, thereby solving the problem of low software running speed and high requirements for equipment hardware when downloading or loading the 3D human body model; and improving the user's viewing efficiency and working efficiency.

Those skilled in the art will appreciate that the various operations, methods, steps, measures, and solutions discussed in the present disclosure may be alternated, modified, combined, or deleted. Further, other steps, measures, and solutions in the various operations, methods, and processes that have been discussed in this disclosure may also be alternated, modified, rearranged, split, combined, or deleted. Further, steps, measures, and solutions in the related art with various operations, methods, and processes disclosed in the present disclosure may also be alternated, modified, rearranged, decomposed, combined, or deleted.

The terms “first” and “second” are configured for descriptive purposes only and are not to be construed as indicating or implying relative importance or as implicitly designating the number of technical features indicated. Thus, a feature defined as “first” or “second” may explicitly or implicitly include one or more of the features. In the description of the present disclosure, the meaning of “a plurality” means two or more than two unless otherwise specified.

It should be understood that, although the various steps in the flowcharts of the figures are shown in order as indicated by the arrows, the steps are not necessarily performed in the order indicated by the arrows. The steps are performed in no strict order unless explicitly stated herein, and may be performed in other orders. Furthermore, at least a part of the steps in the flowchart of the figure may include a plurality of sub-steps or a plurality of stages, and these sub-steps or stages are not necessarily performed at the same time, but may be performed at different times, and the order of execution thereof is also not necessarily performed in turn, but may be performed in turn or in alternation with other steps or at least a part of the sub-steps or stages of other steps.

It should be noted that, the division of the above modules is only a division of logical functions, and in actual implementation, all or part of them may be integrated into a physical entity, or they may be physically separated. These modules can all be implemented in the form of software calling through processing elements; they can also all be implemented in hardware; some modules can also be implemented in the form of calling software through processing elements, and some modules can be implemented in hardware. For example, the determination module may be a separately established processing element, or may be integrated into a certain chip of the above-mentioned device to be implemented, in addition, it may also be stored in the memory of the above-mentioned device in the form of program code, and a certain processing element of the above-mentioned device may call and execute the function of the above determined module. The implementation of other modules is similar. In addition, all or part of these modules can be integrated together, and can also be implemented independently. The processing element described herein may be an integrated circuit with signal processing capability. In the implementation process, each step of the above-mentioned method or each of the above-mentioned modules can be completed by an integrated logic circuit of hardware in the processor element or an instruction in the form of software.

For example, each module, unit, sub-unit or sub-module may be one or more integrated circuits configured to implement the above method, such as: one or more Application Specific Integrated Circuits (ASICs), or, one or more Digital Signal Processors (DSPs), or one or more Field Programmable Gate Arrays (FPGAs), etc. For another example, when a certain module above is implemented in the form of a processing element calling the program code, the processing element may be a general-purpose processor, such as a Central Processing Unit (CPU) or other processors that can call program codes. For another example, these modules can be integrated together and implemented in the form of a System-On-a-Chip (SOC).

The terms “first”, “second”, etc. in the description and claims of the present disclosure are used to distinguish similar objects, and are not necessarily used to describe a specific order or sequence. It is to be understood that the data so used may be interchanged under appropriate circumstances such that the embodiments of the disclosure described herein are implemented in sequences other than those illustrated or described herein, for example. Furthermore, the terms “including” and “having”, and any variations thereof, are intended to cover non-exclusive inclusion, for example, a process, method, system, product or device including a series of steps or units is not necessarily limited to those expressly listed. Rather, those steps or units may include other steps or units not expressly listed or inherent to these processes, methods, products or devices. In addition, the use of “and/or” in the specification and claims to indicate at least one of the linked objects, such as A and/or B and/or C, is meant to include seven cases including that A alone, that B alone, that C alone, that A and B exist, that B and C exist, that A and C exist, and all of A, B, and C exist. Similarly, the use of “at least one of A and B” in this specification and in the claims should be understood to mean “that A alone, that B alone, or that A and B exists”.

The foregoing is only partial embodiments of the present disclosure, and it should be noted that a person skilled in the art may make improvements and modifications without departing from the principles of the present disclosure, and these improvements and modifications should also fall within the scope of the present disclosure.

1. A method for processing human body model data, comprising:
obtaining three-dimensional (3D) human body model data, and classifying the 3D human body model data into multiple data sets according to a predetermined classification condition, wherein the predetermined classification condition comprises medical anatomy category information and art resource category information;
determining, according to each of the data sets, a duplicate resource in the data set, and reorganized data sets where the duplicate resource is removed; and
packing the duplicate resource into a data package, packing each of the reorganized data sets into a respective data package, and storing all of the data packages.

2. The method according to claim 1, wherein the classifying the 3D human body model data into multiple data sets according to the predetermined classification condition comprises:
determining a medical anatomy classification data group of the 3D human body data according to the medical anatomy category information; and
determining art resource category information corresponding to a medical anatomy system classification, and allocating art resource data that corresponds to the art resource category information and is in the 3D human body model data to the medical anatomy classification data group, to obtain the multiple data sets.

3. The method according to claim 2, wherein before allocating the art resource data that corresponds to the art resource category information and is in the 3D human body model data to the medical anatomy classification data group, the method further comprises:
obtaining operation platform type information of the human body model data, and determining the art resource data according to the operation platform type information.

4. The method according to claim 2, wherein the determining, according to each of the data sets, the duplicate resource in the data set, and reorganized data sets where the duplicate resource is removed comprises:
extracting, from the multiple data sets according to common information in human body medical anatomy category information, data related to the common information, and subjecting the data related to the common information to a duplicate removal process to obtain the duplicate resource; and
deleting the data related to the common information from the multiple data sets to obtain the reorganized data sets.

5. The method according to claim 2, wherein the art resource data comprises skeletal model framework and texture for attaching onto rich skeletal model framework.

6. The method according to claim 1, wherein the packing the duplicate resource into the data package, packing each of the reorganized data sets into the respective data package comprises:
obtaining user privilege information corresponding to the duplicate resource and each of the reorganized data sets, and adding the user privilege information to the data package.

7. The method according to claim 1, wherein the storing all of the data packages comprises:
converting each of the data packages into a respective binary data package; and
storing the binary data packages.

8. The method according to claim 1, wherein the medical anatomy category information comprises at least one of: human body shape classification information, human body organ classification information or human body system classification information;
the art resource category information comprises two-dimensional (2D) resource information and 3D resource information.

9. The method according to claim 1, wherein the packing the duplicate resource into the data package, packing each of the reorganized data sets into the respective data package, and storing all of the data packages comprises:
determining a package directory table according to the duplicate resource and each of the reorganized data sets, and the package directory table comprises multiple pieces of mapping information corresponding to the data packages respectively; and
storing the package directory table.

10. The method according to claim 9, wherein after the packing the duplicate resource into data package, packing each of the reorganized data sets into the respective data package, and storing all of the data packages, the method further comprises:
in response to a data query instruction, displaying the package directory table determined according to the reorganized human body system data sets, wherein the package directory table comprises multiple pieces of mapping information corresponding to the human body system data packages respectively, and the human body system data packages comprises: a locomotor system data package, a nerve system data package, an endocrine system data package, a circulatory system data package, a respiratory system data package, a digestive system data package, a urinary system data package and a genital system data package; and
in response to a request for viewing a piece of mapping information in the package directory table, obtaining and displaying human body system data package corresponding to the request.

11. A method for displaying human body model data, comprising:
in response to a data query instruction, obtaining a data package of a human body model corresponding to the data query instruction, wherein the data package is determined through the method according to claim 1; and
decompressing the data package of the human body model, and displaying the data package.

12. The method for displaying human body model data according to claim 11, wherein the in response to the data query instruction, obtaining the data package of the human body model corresponding to the data query instruction comprises:
in response to the data query instruction, obtaining a package directory table determined according to the reorganized human body system data set and displaying the package directory table, wherein the package directory table comprises multiple pieces of mapping information corresponding to the human body system data packages respectively, and the human body system data packages comprise: a locomotor system data package, a nerve system data package, an endocrine system data package, a circulatory system data package, a respiratory system data package, a digestive system data package, a urinary system data package and a genital system data package; and
in response to a request for viewing a piece of mapping information in the package directory table, obtaining a human body system data package corresponding to the request.

13. (canceled)

14. A electronic device comprising a display, and further comprising:
a processor;
a memory electrically connected to the processor; and
at least one program stored in the memory and configured to be executed by the processor, wherein the at least one program is configured to implement the method according to claim 1.

15. A computer readable storage medium storing therein at least one instruction, at least one program, a code set or an instruction set, wherein the at least one instruction, the at least one program, the code set or the instruction set is loaded and executed by a processor to implement the method according to claim 1.

16. The electronic device according to claim 14, wherein the classifying the 3D human body model data into multiple data sets according to the predetermined classification condition comprises:
determining a medical anatomy classification data group of the 3D human body data according to the medical anatomy category information; and
determining art resource category information corresponding to a medical anatomy system classification, and allocating art resource data that corresponds to the art resource category information and is in the 3D human body model data to the medical anatomy classification data group, to obtain the multiple data sets.

17. The electronic device according to claim 16, wherein the at least one program is further configured to: before allocating the art resource data that corresponds to the art resource category information and is in the 3D human body model data to the medical anatomy classification data group,
obtain operation platform type information of the human body model data, and determine the art resource data according to the operation platform type information.

18. The electronic device according to claim 16, wherein the determining, according to each of the data sets, the duplicate resource in the data set, and reorganized data sets where the duplicate resource is removed comprises:
extracting, from the multiple data sets according to common information in human body medical anatomy category information, data related to the common information, and subjecting the data related to the common information to a duplicate removal process to obtain the duplicate resource; and
deleting the data related to the common information from the multiple data sets to obtain the reorganized data sets.

19. The electronic device according to claim 16, wherein the art resource data comprises skeletal model framework and texture for attaching onto rich skeletal model framework.

20. The electronic device according to claim 14, wherein the packing the duplicate resource into the data package, packing each of the reorganized data sets into the respective data package comprises:
obtaining user privilege information corresponding to the duplicate resource and each of the reorganized data sets, and adding the user privilege information to the data package.

21. The electronic device according to claim 14, wherein the storing all of the data packages comprises:
converting each of the data packages into a respective binary data package; and
storing the binary data packages.
